(19) United States
(12) Patent Application Publication
(10) Pub. No.: US 2026/0094066 A1
(43) Pub. Date: Apr. 2, 2026

(54) METHODS AND SYSTEMS FOR ACTIVE MACHINE LEARNING

(71) Applicant: Royal Bank of Canada, Toronto (CA)

(72) Inventors: Frederick TUNG, North Vancouver (CA); Gabriel L. OLIVEIRA, Vancouver (CA); Wonho BAE, Vancouver (CA); Danica J. SUTHERLAND, Vancouver (CA)

(21) Appl. No.: 19/340,187

(22) Filed: Sep. 25, 2025

Related U.S. Application Data
(60) Provisional application No. 63/700,173, filed on Sep. 27, 2024.

(51) Int. Cl. G06N 20/00

(52) U.S. Cl. CPC G06N 20/00

(57) ABSTRACT

Methods and systems are described for selecting a group of data points to be labelled in an active learning process. The method comprises the step of determining a temperature parameter that selects between a representation-based point selection method and an uncertainty-based point selection method based on the current budget. The method also comprises the step of determining a kernel radius parameter that is inversely proportional to the size of the current budget. The method then includes the step of estimating an uncertainty coverage based on the temperature parameter, the kernel radius parameter and the current budget, wherein the uncertainty coverage is a measure of how much uncertainty is covered by the group of data points. Finally, the next point is greedily selected based on the estimated uncertainty coverage.

### CROSS-REFERENCE TO PREVIOUS APPLICATION

This application claims priority from U.S. provisional patent application 63/700,173 filed on Sep. 27, 2024, which is incorporated herein by reference in its entirety.

### FIELD

The present disclosure generally relates to the field of machine learning. In particular, various embodiments are described herein that generally relate to methods and systems for selecting data points to be labeled in an active learning algorithm.

### INTRODUCTION

The following paragraphs are provided by way of background to the present disclosure. They are not, however, an admission that anything discussed therein is prior art or part of the knowledge of persons skilled in the art.

Active learning is a learning framework where a model strategically requests annotations for specific data points, aiming for less manual annotations compared to passive learning. Unlike traditional approaches where all available data is labeled at once, active learning involves an iterative process. The model is initially trained on a small, labeled dataset and then selects the most “informative” data points from an unlabeled pool for annotation. By focusing on these selected data points, active learning ensures that the model learns from the most valuable information, leading to improved performance with fewer labeled examples.

It is particularly useful in scenarios where labeling is expensive or time-consuming. For example, in medical imaging, there is often a large repository of unlabeled X-ray or MRI images. However, labeling these images requires manual annotations by radiologists or pathologists, which is time consuming and costly. In manufacturing, there is often a large amount of sensor data generated during the production process. Annotating them to identify patterns indicating quality issues requires domain experts. On the other hand, in banking, discovering a customer's product preferences may require sending a large number of different offers, which can be both time-consuming and produce a poor customer experience.

The core idea of active learning is for the model to identify the most informative data points in the future. The most popular line of work in active learning has used uncertainty to measure informativeness of each data point and selected data points based on that. Although these uncertainty-based approaches work well, recent works such as in [15] and [46] have shown that it is only true in high budget regimes where there is a large enough set of labeled data points. In low budget regimes, however, representation-based approaches seem to work significantly better. These representation-based approaches focus on selecting the most “representative” data points, and often rely on clustering methods e.g., k-means.

In practice, however, it is challenging to accurately determine the appropriate budget regime, as it depends on factors such as dataset characteristics and model architecture. To address this, [14] propose an algorithm that determines a budget regime a model is at and selects an active learning method accordingly. However, it assumes discrete budget regimes, cannot utilize uncertainty measures, and requires a significant number of re-trainings, which may not be feasible with large neural networks.

There is a need for methods and systems for selecting data points to be labeled in an active learning algorithm that address the challenges and/or shortcomings described above.

### SUMMARY

Various embodiments of methods and systems for selecting data points to be labeled in an active learning algorithm are provided according to the teachings herein. These methods and systems select representative points initially and, as iterations progress, increasingly focuses on the points that cover the most uncertain points on average, which are typically near the decision boundary.

According to an aspect of the present disclosure, there is provided a method for selecting a group of data points to be labelled in an active learning process. The method comprises determining a temperature parameter that selects between a representation-based point selection method and an uncertainty-based point selection method based on the current budget. The method also comprises determining a kernel radius parameter that is inversely proportional to the size of the current budget. The method also comprises estimating an uncertainty coverage based on the temperature parameter, the kernel radius parameter and the current budget, wherein the uncertainty coverage is a measure of how much uncertainty is covered by the group of data points. The method also comprises greedily selecting a next point based on the estimated uncertainty coverage.

In some examples, the representation-based data point selection method is a MaxHerding method.

In some examples, the uncertainty-based data point selection method of a Margin method.

In some examples, the step of greedily selecting a next point based on the estimated uncertainty coverage is repeated with an updated kernel value to the closest labeled data point until the budget is spent.

In some examples, the method is repeated for a number of iterations, and wherein the labeled and unlabeled data sets are updated before each iteration.

According to another aspect of the present disclosure, there is provided a non-transitory computer-readable storage medium storing a plurality of instructions executable by one or more processors, the plurality of instructions when executed by the one or more processors cause the one or more processors to execute the above method.

According to yet another aspect of the present disclosure, there is provided a system comprising one or more computer processors and one of more computer readable storage media for storing computer-implemented instructions. The one or more computer processors are configured to execute the computer-implemented instructions to cause the computer system to perform the above method.

Other features and advantages of the present disclosure will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. In the drawings:

FIG. 1 shows a computer network suitable for implementing embodiments in accordance with systems and methods of the present disclosure;

FIG. 2 shows a computing device suitable for implementing embodiments in accordance with systems and methods of the present disclosure;

FIG. 3 is flowchart representing embodiments in accordance with methods of the present disclosure;

FIG. 4 shows a scatterplot of the result of a herding method in accordance with the prior art;

FIG. 5 shows a scatterplot of the result of another herding method in accordance with the prior art; and

FIG. 6 shows a scatterplot of the result of a herding method in accordance with embodiments of the present disclosure.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to systems or methods having all of the features of any one of the systems or methods described below or to features common to multiple or all of the systems or methods described herein. It is possible that there may be a system or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Some elements herein may be identified by a part number, which is composed of a base number followed by an alphabetical or numerical suffix (e.g., 184A, or 1841). Multiple elements herein may be identified by part numbers that share a base number in common and that differ by their suffixes (e.g., 1841, 1842, and 1843). All elements with a common base number may be referred to collectively or generically using the base number without a suffix (e.g., 184).

The example embodiments of the systems or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including one or more of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level programming language. The program code may be written in Rust, C++, C#, JavaScript, Python, or any other suitable programming language and may comprise modules or classes, as is known to those skilled in the art. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, solid-state storage, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the systems and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

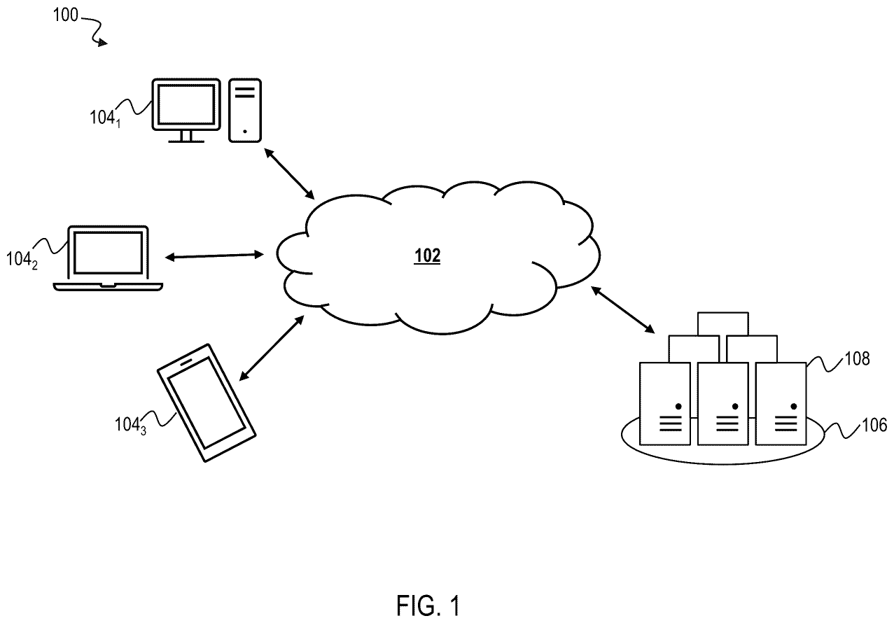

Referring now to FIG. 1, there is shown a computer network 100 that comprises an example embodiment of a system implementing the systems and methods described herein. More particularly, the computer network 100 comprises a wide area network 102 such as the Internet to which various computing devices 104ₓ, and cloud computing service 106 are communicatively coupled. The cloud computing service 106 may comprise a number of computing devices 108 networked together to collectively perform various computing functions. For example, in the context of machine learning, the cloud computing service 106 may host machine learning models, such as those described herein, and associated functionality.

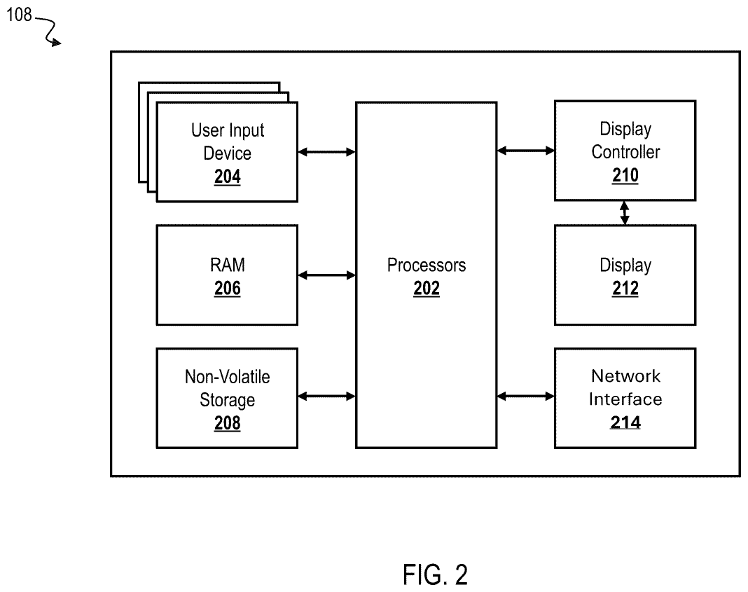

Referring now to FIG. 2, there is depicted an example embodiment of one of the computing devices 108 that comprises the cloud computing service 106. The computing device 108 comprises processors 202 that control the computing device's 108 overall operation. The processors 202 are communicatively coupled to and controls several subsystems. Processors 202 may include one or more graphical processing unit (GPU). The GPU may be used for computational purposes as an adjunct to, or instead of, a central processing unit (CPU), for mathematical calculations.

These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other computing devices 108 in the data center 106.

The non-volatile storage 208 has stored on it computer program code that is loaded into the RAM 206 at runtime and that is executable by processors 202. When the computer program code is executed by the processors 202, the processors 202 cause the computing device 108 to implement methods such as those described herein. Additionally, or alternatively, the computing devices 108 may collectively perform the method described herein using distributed computing. While the system depicted in FIG. 2 is described specifically with respect to one or more of the computing devices 108, analogous versions of the system may also be used within computing devices 104ₓ.

The term “computing device” and related terms, as used herein, is not limited to any particular type of computer system and encompasses servers, desktop computers, laptop computers, networked mobile wireless telecommunication computing devices such as smartphones, tablet computers, as well as other types of computer systems.

Active learning aims to reduce the need for manual data annotation by strategically selecting which data points to annotate. The three main approaches to active learning are uncertainty-based methods, representation-based methods, and hybrid methods that combine both.

Uncertainty-based methods are simple but effective methods that rely on a model at an iteration, include entropy, see [47], margin [38], confidence, and posterior probability (see [29] and [30]). In the Bayesian setting, BALD (see [14]) and BatchBALD (see [23]) utilize mutual information between labels and model parameters. On the other hand, BAIT (see [3]) selects data points that minimize Bayes risk. Instead of using a snapshot of a trained model, the method described in [27] exploits uncertainties computed in the process of model training, which is particularly helpful for long-tailed datasets.

Other than methods relying on the past or present of a model, there are “looking-ahead” approaches, which select data points based on how much selected data points change either model or generalization. For instance, the approaches utilizing expected model changes (see [42], [44] and [2]), measure how the selected data points would change the model parameters and select the ones that change the model the most. Expected error reduction (see [37], [53], and [16]) instead measures how much error would be reduced in expectation whereas expected model output change (see [14], [21] and [22]) measures change of outputs given unlabeled data points. Due to the necessity of re-training models, look-ahead approaches have been applied only for small models such as Näive Bayes. Some methods (see [33]) utilize Neural Tangent Kernel (NTK) (see [20], [28], and [34]), making look-ahead approaches feasible for neural networks.

Other prior art methods, such as representation-based approaches, aim to select the most “representative” data points, expecting that the selected data points represent (or cover) the data distribution. Simple but effective traditional methods include k-means (see [50]) and its variants such as k-medoids (see [1]) and k-medians (see [46]). More recently, other methods (see [41]) convert the objective of active learning into the problem of maximum coverage, proposing greedy k-center algorithms. Instead of finding the minimum radius that covers all the data points, the ProbCover method (see [51]) fix the radius parameter and select data points that cover the unlabeled data points the most. The MaxHerding method (see [5]) generalizes the notion of probability coverage introduced by [51], which is more effective and robust to the radius parameter.

Recently, others (see [18]) have demonstrated that representation-based methods are particularly more useful than uncertainty-based methods in low-budget regimes. In such regimes, the Typiclust method (see [18]) select a data point for each k-means cluster at the most dense region by computing typicality scores. Another method (see [31]) utilizes the objective that minimizes the Wasserstein distance between the labeled and unlabeled data distributions. Similarly, the ActiveFT method (see [49]) selects data points that minimize the KL-divergence between the labeled and unlabeled data distributions, regularized by a diversity term particularly for transfer learning tasks. Other methods (see [6]) exploit determinantal point processes (see [26]) to select representative points.

Other prior art methods include hybrid methods, which combine the measure of uncertainty and diversity, these approaches aim to select informative data points that are not outliers. For example, some hybrid methods (see [35] and [10]) select data points based on the margin between the highest and second highest prediction probability, weighted by clustering scores. Other (see [43]) weight uncertainty measures, particularly entropy, by cosine similarity.

With modern neural network architectures, the BADGE method (see [4]) selects data points using k-means++ initialization algorithm based on the gradient of a loss with respect to the features from a penultimate layer. The ALFA-Mix method (see [36]) runs k-means only using uncertain data points selected based on the interpolation of features.

Since uncertainty and representation-based active learning approaches behave differently in different budget regimes (see [17]), some have investigated where to switch from low-budget methods to high-budget methods. Although the SelectAL method (see [17]) successfully finds the switching point, it assumes there is a discrete number of budget regimes, cannot utilize uncertainty-based methods, and relies on many re-training operations of a model (in a scale of tens).

The systems and methods disclosed herein provide a more robust approach with minimal re-training, covering continuous budget regimes.

The most common framework in active learning is pool-based active learning where at each step for t∈[1, 2, . . . , T], a labeled set [symbol] ₜ is iteratively expanded by querying a set of new data points

$${𝒮}_{t} = {\{ {x}_{b} \}}_{b = 1}^{{B}_{t}}$$

from an unlabeled pool of data points [symbol] ₜ. A pre-defined model ƒ is then trained on them. Typically, the most important part of active learning is how to strategically select new data points to annotate.

Some prior art methods (see [5]) use the concept of generalized coverage Cₖ_{_{σ}}( [symbol] ), which generalizes the probability coverage proposed in the ProbCover method (See [51]) where k is a real-valued nonnegative function that takes two inputs and a function g:χ→ [symbol] , mapping an input x to a feature v∈ [symbol] . It is defined and approximated as follows:

$${C}_{{k}_{σ}} ( 𝒮 ) = {𝔼}_{x} [ {max}_{{x}^{′} ∈ 𝒮} {k}_{σ} ( x , {x}^{′} ; g ) ] \approx \frac{1}{N} {\sum }_{n = 1}^{N} ( {max}_{{x}^{′} ∈ 𝒮} {k}_{σ} ( {x}_{n} , {x}^{′} ; g ) ) \text{=:} {\hat{C}}_{{k}_{σ}} ( 𝒮 ) . \qquad ( 1 )$$

An example of a function k is a radial basis function (RBF) kernel defined as,

$${k}_{σ} ( x , {x}^{′} ; g ) = exp ( - \frac{1}{{σ}^{2}} {‖ g ( x ) - g ( \tilde{x} ) ‖}^{2} ) .$$

It is possible to use (see [5]) self-supervised learning feature extractors as a function g (e.g., SimCLR described in [7]). MaxHerding is an active learning method that greedily selects data points maximizing the estimated generalized coverage: x*= [symbol] Ĉₖ_{_{σ}}( [symbol] ∪{\tilde{x}}). As used herein, greedy algorithms are a class of algorithms that make a sequence of choices, each of which looks the best at a particualr moment. The core principle is to make the locally optimal choice at each step, trading off global optimality for efficiency.

k-means clustering is known in active learning to promote diversity in the selection process. For example, the BADGE method (see [4]) employs k-means++ initialization, the ALFA-Mix method (see [36]) clusters selected candidate data points using k-means, and the Typiclust method (see [18]) partitions unlabeled data into clusters with k-means.

k-means clustering in active learning, however, has two potential problems. The first is that some k-means centroids may be far from the nearest sample in the unlabeled set, or may not represent any unlabeled points. The second is that a natural solution to the first problem would be to use k-medoids, but finding k-medoids through iterative update (as is done with k-means) often leads to poor local optima (see [40]).

Partitioning Around Medoids (PAM) (see [39]) typically produces better clustering results. It remains however much slower compared to iterative updates. MaxHerding, a

$$( 1 - \frac{1}{e} ) -$$

approximation algorithm, finds solutions as good as variants of PAM algorithms, significantly outperforms Faster PAM (see [40]) in terms of speed for active learning (see [5]).

As has been appreciated by the inventors, MaxHerding achieves significantly better performance than both k-means and k-means++ for active learning. Accordingly, in accordance with the disclosure found herein, k-means has been replaced with MaxHerding for the theoretical analysis of some k-means-based active learning methods, without compromising their effectiveness.

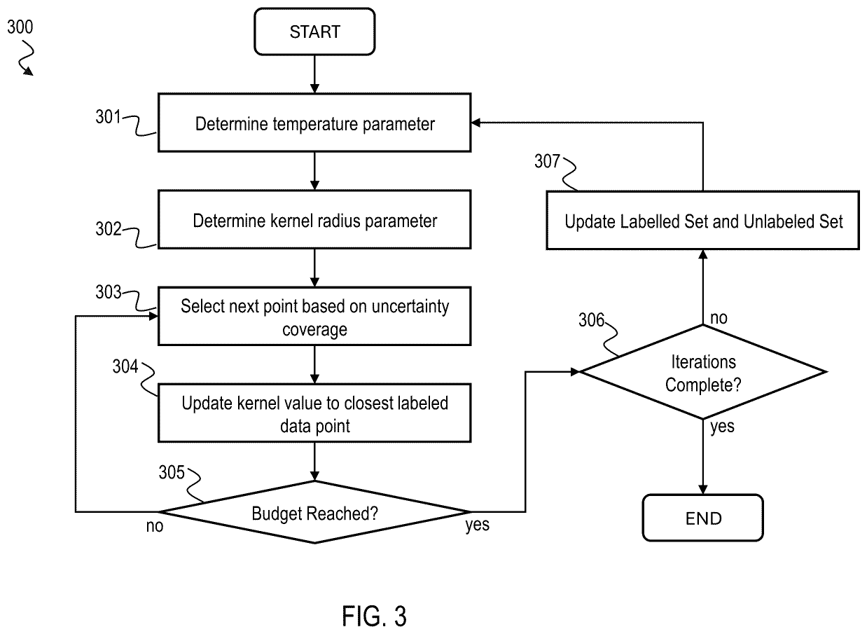

The algorithm performed by computing device 108 and/or cloud computing service 106 is summarized by pseudo-code as Algorithm 1 below, and shown in FIG. 3, where U is a positive-valued uncertainty function, as defined in more detail elsewhere herein.

```
Algorithm 1: Uncertainty herding with parameter adaptation
Input: Initial labeled set [symbol] ₀, Initial unlabeled set [symbol] ₀, budget B, set of temperatures [symbol]  , number
of iterations T, a classifier f, and a feature extractor g
for t ∈ [0, 1, . . . , T − 1] do
  // Parameter adaptation
  $Compute {τ}^{*} = arg {min}_{τ ∈ 𝒯} ECE ( {f}_{{ℒ}_{t}^{train}} , {ℒ}_{t}^{val} ) where {ℒ}_{t}^{train} and {ℒ}_{t}^{val} are random split from$
  ${ℒ}_{t} , and {f}_{{ℒ}_{t}^{train}} refers to a classifier f trained on {ℒ}_{t}^{train}$
  $Compute k ∈ {R}^{\vert {𝒰}_{t} \vert} with {k}_{n} = {max}_{{x}^{′} ∈ {ℒ}_{t}} {k}_{{σ}^{*}} ( {x}_{n} , {x}^{′} ) for {σ}^{*} = {min}_{u , v ∈ {ℒ}_{t} , u \neq v} D ( u , v ; g )$
  // Greedy selection based on the uncertainty coverage
  for b ∈ [1, 2, . . . , B] do
    $Select {x}_{b}^{*} = arg {max}_{\tilde{x} ∈ 𝒰} \frac{1}{N} {\sum }_{n = 1}^{N} U ( {x}_{n} ) \cdot max ( {k}_{{σ}^{*}} ( {x}_{n} , \tilde{x} ) - {k}_{n} , 0 )$
    $Update {k}_{n} ← max ( {k}_{{σ}^{*}} ( {x}_{n} , {x}_{b}^{*} ) , {k}_{n} )$
  end for
  $Update {ℒ}_{t + 1} ← {ℒ}_{t} ⋃ {\{ {x}_{b}^{*} \}}_{b = 1}^{B} and {𝒰}_{t + 1} ← {𝒰}_{t} \backslash {\{ {x}_{b}^{*} \}}_{b = 1}^{B}$
end for
```

As shown in FIG. 3, at step 301 of the method temperature parameter [symbol] (step 301) is determined. Then, at step 302, a kernel radius parameter σ is determined. Then, at step 303, the next point

$${x}_{b}^{*}$$

is selected based on an uncertainty coverage calculated using the temperature parameter and the kernel radius parameter. The kernel value to the closest labeled data point k is then updated at step 304.

As can be seen from FIG. 3 (see step 305), steps 303 and 304 will be repeated until the budget B has been reached. When the budget has been reached, a determination will be made as to whether the number of iterations T−1 has been reached. If it has been reached, the method will end. If not, the labeled set [symbol] and unlabeled set [symbol] will be updated at step 307 and the method will return to step 301.

As described in [18] and [51], representation-based methods consistently outperform uncertainty-based methods in low-budget regimes, while the reverse holds true in high-budget regimes. However, identifying the specific budget regime in practice, and thus selecting the most appropriate active learning strategy, remains challenging. Although the SelectAL method (see [17]) attempts to address this issue by identifying budget regimes, its practical utility is limited for the reasons outlined in more detail elsewhere herein.

The methods and systems disclosed herein relate to a novel approach, which is referred to herein as Uncertainty Herding (or “UHerding”). The methods and systems disclosed herein aim to “interpolate” between representation-based methods, for example MaxHerding, and uncertainty-based methods, offering a robust effectiveness across different budget regimes.

As used herein, “uncertainty coverage” is a measure of how much uncertainty is covered by a set of data points. For example, for any subset [symbol] ⊂ [symbol] , a real-valued radius-based function k_{σ}, and positive-valued uncertainty function U, the uncertainty coverage is defined as:

$${UC}_{{k}_{σ}} ( 𝒮 ) = {𝔼}_{x} [ U ( x ; f ) \cdot {max}_{{x}^{′} ∈ 𝒮} {k}_{σ} ( x , {x}^{′} ; g ) ] . \qquad ( 2 )$$

Here, the uncertainty function U takes a model ƒ which is updated for each iteration t whereas k_{σ} utilizes a fixed feature extractor g. The uncertainty coverage weights the generalized coverage Equation (1), above, with a choice of uncertainty measure U(x). The uncertainty coverage can then be approximated using Monte Carlo approximation as:

$${UC}_{{k}_{σ}} ( 𝒮 ) \approx {{k}_{σ}}_{} ( 𝒮 ) = \frac{1}{N} {\sum }_{n = 1}^{N} U ( {x}_{n} ; f ) \cdot {max}_{{x}^{′} ∈ 𝒮} {k}_{σ} ( {x}_{n} , {x}^{′} ; g ) . \qquad ( 3 )$$

As done in [5], it can now be shown that

$$Pr ( \vert {{k}_{σ}}_{} ( 𝒮 ) - {UC}_{{k}_{σ}} ( 𝒮 ) \vert \leq ( b - a ) \sqrt{\frac{2}{N} log \frac{2}{δ}} ) \geq 1 - δ$$

where a≤U(x;ƒ)·k(x,x′;g)≤b, by Hoeffding's inequality. For instance, if 0≤k(x,x′;g)≤1 e.g., RBF kernel, and 0≤U(x;ƒ)≤1 e.g., margin between the highest and second highest probabilities, a and b are equal to 0 and 1, respectively. Given that N is usually very large (as it is the size of the unlabeled set [symbol] ), [symbol] ₖ_{_{σ}}( [symbol] ) is a close approximation to UCₖ_{_{σ}}( [symbol] ).

Following conditions show how the uncertainty coverage can asymptotically be equivalent to the generalized coverage and uncertainty measure.

Proposition 1: If ∀x∈ [symbol] , U(x;ƒ)→c where c≥0, the estimated uncertainty coverage [symbol] ₖ_{_{σ}}( [symbol] ) approaches to the estimated generalized coverage Ĉₖ_{_{σ}}( [symbol] ) up to a constant.

The uncertainty coverage is also asymptotically equivalent to the uncertainty measure of a choice.

Proposition 2: If a radius σ→0 for k_{σ}, the estimated uncertainty coverage [symbol] ₖ_{_{σ}}( [symbol] ) approaches to a batch uncertainty measure, defined as

$${\sum }_{s = 1}^{\vert 𝒮 \vert} U ( {x}_{s} ; f ) ,$$

up to a constant.

Now that the conditions that make the uncertainty coverage approach the generalized coverage and uncertainty measure are known, it is desirable for the uncertainty coverage to be close to the generalized coverage particularly in low-budget regimes where | [symbol] | is small, and to gradually move towards the uncertainty measure as | [symbol] | increases.

For low-budget regimes, to satisfy the former through Proposition 1, as described elsewhere herein, it is possible to employ temperature scaling, a post-hoc model calibration method. As described elsewhere herein, the method may include the following steps.

The first step is to split the labeled set [symbol] ₜ at step t into train [symbol] and validation [symbol] . The second step is to train a model ƒ on [symbol] ; a trained model is denoted as [symbol] . The third step is to choose

$${τ}^{*} = arg {min}_{τ ∈ T} ECE ( {f}_{{ℒ}_{t}^{train}} , {ℒ}_{t}^{val} )$$

where ECE refers to the expected calibration error, which measures how a model is well-calibrated using a validation set [symbol] . Finally, step includes computing uncertainties with temperature τ*; for example, with a temperature scaled softmax:

$${s ( f ( x ) , τ )}_{c} ∝ {f ( x )}_{c} / τ , \text{} {U}_{Entropy} ( x ; f , {τ}^{*} ) = - {\sum }_{c = 1}^{K} {s ( f ( x ) , {τ}^{*} )}_{c} \cdot log {s ( f ( x ) , {τ}^{*} )}_{c}$$

where K is the number of classes.

The optimal temperature τ* generally starts with a high value when | [symbol] | is small, but gradually decrease as | [symbol] | increases. When there is only limited number of data in the labeled set, a model ƒ tends to overfit to the labeled set whereas when the labeled set is large enough, a model does not overfit as much and its predictions become more reliable.

For high-budget regimes, to make the uncertainty coverage approach the choice of uncertainty measure as | [symbol] | increases, it is possible to adaptively decrease the radius parameter σ. The influence of a new data point tends to decrease as | [symbol] | increases, which implies that it is reasonable to reduce the radius, a parameter adjusting closeness, as there are more labeled data. Thus, we choose the radius to be the minimum distance between data points in the labeled set [symbol] as:

$${σ}^{*} = {min}_{u , v ∈ {ℒ}_{t} , u \neq v} D ( u , v ; g ) , where D ( u , v ; g ) = {‖ g ( u ) - g ( v ) ‖}_{2} . \qquad ( 4 )$$

As stated in Proposition 2, as described elsewhere herein, [symbol] ₖ_{_{σ}}( [symbol] ) converges to the uncertainty measure as σ*→0.

In some embodiments, it is desirable to use a well-calibrated classifier, especially for low-budget regimes to avoid overfitting. The temperature scaling described elsewhere herein is a part of making a classifier better calibrated. In addition to that, it is possible to use entropy regularization for a loss: [symbol] ₑₙₜ(ŷ,y)= [symbol] _{ce}(ŷ,y)+ [symbol] (ŷ|x), as it promotes calibration for a classifier.

Selecting data points naïvely maximizing the estimated uncertainty coverage in Equation (3) is not robust for different budget constraints. On the other hand, a selection maximizing the estimated uncertainty coverage with the parameter adaption significantly improves the robustness of data selection.

In some embodiments of the present disclosure, the methods disclosed herein comprise the following steps. Using the estimated uncertainty coverage [symbol] ₖ_{_{σ}}, it is possible to select data both greedily and non-greedily.

Non-greedy selection may include the following. It is possible to select data points in batch by solving the following objective:

$${𝒮}^{*} ⊂ arg {max}_{𝒮 ⊂ 𝒰 , \vert 𝒮 \vert = B} {}_{{k}_{σ}} ( ℒ ⋃ 𝒮 ) = arg {max}_{𝒮 ⊂ 𝒰 , \vert 𝒮 \vert = B} \frac{1}{N} {\sum }_{n = 1}^{N} U ( {x}_{n} ; f ) \cdot {max}_{{x}^{′} ∈ ℒ ⋃ 𝒮} {k}_{σ} ( {x}_{n} , {x}^{′} ; g ) , \qquad ( 5 )$$

where ƒ is a classifier and g is a self-supervised learning feature extractor.

It is in fact the same as a weighted kernel k-means or medoids objective where weights are determined by an uncertainty measure U(x; ƒ). Thus, it is possible to select a set of data points [symbol] using kernel k-means or medoids algorithms, particularly Partition Around Medoids (PAM). It is, however, slower than the greedy method described elsewhere herein. Although iterative update (generally used for k-means) is significantly faster than PAM, it often falls into poor local optima.

In some embodiments, greedy selection may include the following. As mentioned elsewhere herein, compared to non-greedy algorithms, greedy selection is usually significantly faster without losing much performance.

For the reasons set out elsewhere herein, Uncertainty Herding (or “UHerding”), includes a greedy selection of data points by maximizing the estimated uncertainty coverage with adaptive parameters: temperature τ* and radius σ*:

$${\tilde{x}}^{*} ⊂ arg {max}_{\tilde{x} ∈ 𝒰} {{k}_{σ}}_{} ( ℒ ⋃ \{ \tilde{x} \} ) = arg {max}_{\tilde{x} ∈ 𝒰} ( \frac{1}{N} {\sum }_{n = 1}^{N} U ( {x}_{n} ; f , {τ}^{*} ) \cdot {max}_{{x}^{′} ∈ ℒ ⋃ \{ \tilde{x} \}} {k}_{σ} * ( {x}_{n} , {x}^{′} ; g ) ) \qquad ( 6 )$$

The methods and systems disclosed herein (also referred to herein as “UHerding”) enhance traditional uncertainty measures by considering not only the uncertainty of a selected point but also the reduction in uncertainty for surrounding points it influences. This contrasts with methods that solely focus on the uncertainty of a selected point. Furthermore, unlike MaxHerding, which ignores uncertainty (and also the predictions of a classifier ƒ), UHerding incorporates these factors, making it more adaptable as a labeled dataset grows.

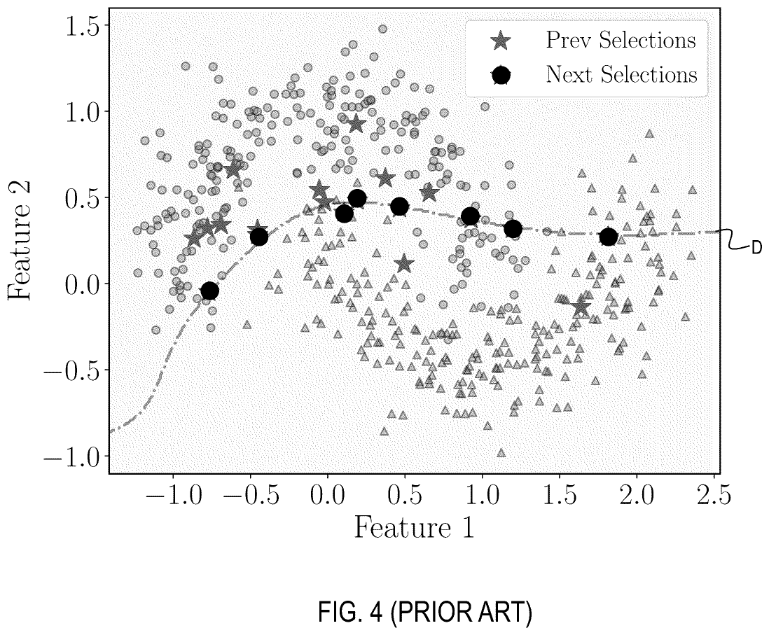

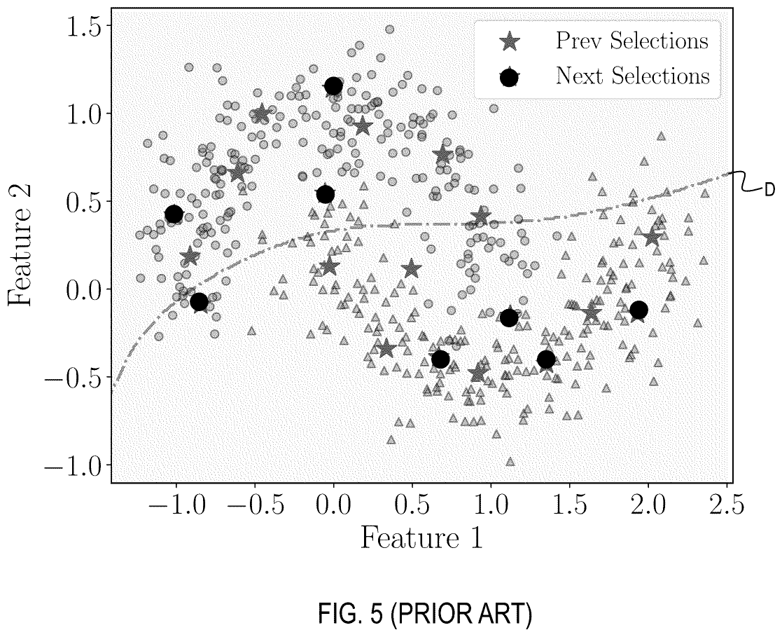

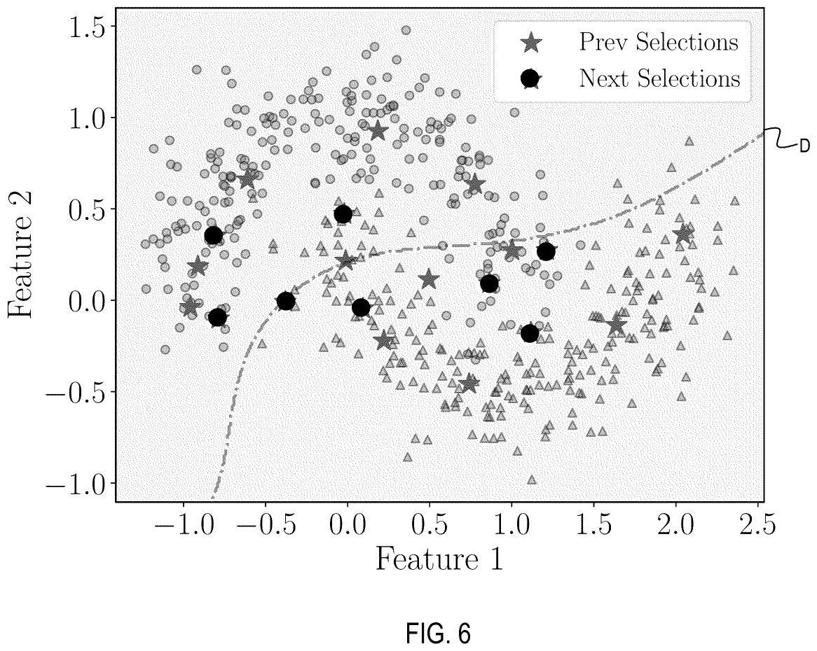

FIGS. 4 to 6 visually compare next selected data points (represented by larger dark circles) by Margin (FIG. 4), MaxHerding (FIG. 5), and UHerding using Margin uncertainty (FIG. 6) on a two-class half-moon dataset represented by circles and triangles. A logistic regression model with fifth-order polynomial features is trained at each selection iteration, and the decision boundary D after trained on 12 previously selected data points (represented by star shapes) is plotted as dashed lines.

As expected, and as shown in FIG. 4, Margin selects data points near the decision boundary D, which may lead to suboptimal models when the predicted boundary deviates from the true decision boundary.

As shown in FIG. 5, MaxHerding, on the other hand, selects the most representative points based on prior selections, without considering model predictions. While this helps the model generalize quickly with a small number of labeled points, its performance saturates after several iterations, as it neglects points near the decision boundary.

Finally, as shown in FIG. 6, the methods and system described herein offer a balanced approach because they start by selecting representative points and gradually shifts towards covering more uncertain points-typically near the decision boundary-thereby significantly improving performance over time.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

### REFERENCES

[1] Amin Aghaee, Mehrdad Ghadiri, and Mahdieh Soleymani Baghshah. Active distance-based clustering using k-medoids. In PAKDD, 2016.
[2] Jordan Ash and Ryan P Adams. On warm-starting neural network training. In NeurIPS, 2020.
[3] Jordan Ash, Surbhi Goel, Akshay Krishnamurthy, and Sham Kakade. Gone fishing: Neural active learning with fisher embeddings. 2021.
[4] Jordan T Ash, Chicheng Zhang, Akshay Krishnamurthy, John Langford, and Alekh Agarwal. Deep batch active learning by diverse, uncertain gradient lower bounds. In ICLR, 2020.
[5] Wonho Bae, Junhyug Noh, and Danica J Sutherland. Generalized coverage for more robust low-budget active learning. In ECCV, 2024.
[6] Erdem Biyik, Kenneth Wang, Nima Anari, and Dorsa Sadigh. Batch active learning using determinantal point processes. In NeurIPS, 2019.
[7] Ting Chen, Simon Kornblith, Mohammad Norouzi, and Geoffrey Hinton. A simple framework for contrastive learning of visual representations. In ICML, 2020.
[8] Wei-Yu Chen, Yen-Cheng Liu, Zsolt Kira, Yu-Chiang Frank Wang, and Jia-Bin Huang. A closer look at few-shot classification. In ICLR, 2019.
[9] Jia Deng, Wei Dong, Richard Socher, Li-Jia Li, Kai Li, and Li Fei-Fei. ImageNet: A large-scale hierarchical image database. In CVPR, 2009.
[10] Pinar Donmez, Jaime G Carbonell, and Paul N Bennett. Dual strategy active learning. In ECML, 2007.
[11] Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al. An image is worth 16×16 words: Transformers for image recognition at scale. 2021.
[12] Paul Doucet, Benjamin Estermann, Till Aczel, and Roger Wattenhofer. Bridging diversity and uncertainty in active learning with self-supervised pre-training. In ICLR Workshop, 2024.
[13] Alexander Freytag, Erik Rodner, and Joachim Denzler. Selecting influential examples: Active learning with expected model output changes. In ECCV, 2014.
[14] Yarin Gal, Riashat Islam, and Zoubin Ghahramani. Deep bayesian active learning with image data. In ICML, 2017.
[15] Micah Goldblum, Steven Reich, Liam Fowl, Renkun Ni, Valeriia Cherepanova, and Tom Goldstein. Unraveling meta-learning: Understanding feature representations for few-shot tasks. In ICML, 2020.
[16] Yuhong Guo and Russell Greiner. Optimistic active-learning using mutual information. In IJCAI, pp. 823-829, 2007.
[17] Guy Hacohen and Daphna Weinshall. How to select which active learning strategy is best suited for your specific problem and budget. In NeurIPS, 2024.
[18] Guy Hacohen, Avihu Dekel, and Daphna Weinshall. Active learning on a budget: Opposite strategies suit high and low budgets. In ICML, 2022.
[19] Kaiming He, Xiangyu Zhang, Shaoqing Ren, and Jian Sun. Deep residual learning for image recognition. In CVPR, pp. 770-778, 2016.
[20] Arthur Jacot, Franck Gabriel, and Cl' ement Hongler. Neural tangent kernel: Convergence and generalization in neural networks. In NeurIPS, 2018.
[21] Christoph Käding, Erik Rodner, Alexander Freytag, and Joachim Denzler. Active and continuous exploration with deep neural networks and expected model output changes. In NIPSW, 2016.
[22] Christoph Käding, Erik Rodner, Alexander Freytag, Oliver Mothes, Björn Barz, Joachim Denzler, and Carl Zeiss A G. Active learning for regression tasks with expected model output changes. In BMVC, 2018.
[23] Andreas Kirsch, Joost Van Amersfoort, and Yarin Gal. Batchbald: Efficient and diverse batch acquisition for deep bayesian active learning. In NeurIPS, 2019.
[24] Alex Krizhevsky. Learning multiple layers of features from tiny images, 2009.
[25] Alex Krizhevsky, Vinod Nair, and Geoffrey Hinton. Cifar-100 (canadian institute for advanced research). URL http://www.cs.toronto.edu/“kriz/cifar.html.
[26] Alex Kulesza, Ben Taskar, et al. Determinantal point processes for machine learning. Foundations and Trends® in Machine Learning, 2012.
[27] Seong Min Kye, Kwanghee Choi, Hyeongmin Byun, and Buru Chang. Tidal: Learning training dynamics for active learning. In ICCV, 2023.
[28] Jaehoon Lee, Lechao Xiao, Samuel Schoenholz, Yasaman Bahri, Roman Novak, Jascha Sohl-Dickstein, and Jeffrey Pennington. Wide neural networks of any depth evolve as linear models under gradient descent. In NeurIPS, 2019.
[29] David D Lewis and Jason Catlett. Heterogeneous uncertainty sampling for supervised learning. In Machine learning proceedings 1994, pp. 148-156, 1994.
[30] David D Lewis and William A Gale. A sequential algorithm for training text classifiers. In SIGIR, pp. 3-12, 1994.
[31] Rafid Mahmood, Sanja Fidler, and Marc T Law. Low budget active learning via wasserstein distance: An integer programming approach. In ICLR, 2022.
[32] Mohammed Ali mnmoustafa. Tiny imagenet, 2017. URL https://kaggle.com/competitions/tiny-imagenet.
[33] Mohamad Amin Mohamadi, Wonho Bae, and Danica J Sutherland. Making look-ahead active learning strategies feasible with neural tangent kernels. In NeurIPS, 2022.
[34] Mohamad Amin Mohamadi, Wonho Bae, and Danica J Sutherland. A fast, well-founded approximation to the empirical neural tangent kernel. In ICML, 2023.
[35] Hieu T Nguyen and Arnold Smeulders. Active learning using pre-clustering. In ICML, 2004.
[36] Amin Parvaneh, Ehsan Abbasnejad, Damien Teney, Gholamreza Reza Haffari, Anton Van Den Hengel, and Javen Qinfeng Shi. Active learning by feature mixing. In CVPR, 2022.
[37] Nicholas Roy and Andrew McCallum. Toward optimal active learning through monte carlo estimation of error reduction. In ICML, 2001.
[38] Tobias Scheffer, Christian Decomain, and Stefan Wrobel. Active hidden markov models for information extraction. In ISIDA, 2001.
[39] Erich Schubert and Peter J Rousseeuw. Faster k-medoids clustering: improving the PAM, CLARA, and CLARANS algorithms. In Similarity Search and Applications: 12th International Conference, SISAP 2019, Newark, NJ, USA, Oct. 2-4, 2019, Proceedings 12, pp. 171-187, 2019.
[40] Erich Schubert and Peter J Rousseeuw. Fast and eager k-medoids clustering: O(k) runtime improvement of the PAM, CLARA, and CLARANS algorithms. Information Systems, 2021.
[41] Ozan Sener and Silvio Savarese. Active learning for convolutional neural networks: A core-set approach. In ICLR, 2018.
[42] Burr Settles. Active learning literature survey. University of Wisconsin-Madison Department of Computer Sciences, 2009.
[43] Burr Settles and Mark Craven. An analysis of active learning strategies for sequence labeling tasks. In EMNLP, 2008.
[44] Burr Settles, Mark Craven, and Soumya Ray. Multiple-instance active learning. pp. 1289-1296, 2007.
[45] Hugo Touvron, Matthieu Cord, Matthijs Douze, Francisco Massa, Alexandre Sablayrolles, and Hervé Jégou. Training data-efficient image transformers & distillation through attention. In ICML, 2021.
[46] Konstantin Voevodski, Maria-Florina Balcan, Heiko Röglin, Shang-Hua Teng, and Yu Xia. Active clustering of biological sequences. In JMLR, 2012.
[47] Dan Wang and Yi Shang. A new active labeling method for deep learning. In IJCNN, 2014.
[48] Yan Wang, Wei-Lun Chao, Kilian Q. Weinberger, and Laurens van der Maaten. Simpleshot: Revisiting nearest-neighbor classification for few-shot learning. arXiv preprint arXiv:1911.04623, 2019.
[49] Yichen Xie, Han Lu, Junchi Yan, Xiaokang Yang, Masayoshi Tomizuka, and Wei Zhan. Active finetuning: Exploiting annotation budget in the pretraining-finetuning paradigm. In CVPR, 2023.
[50] Zhao Xu, Kai Yu, Volker Tresp, Xiaowei Xu, and Jizhi Wang. Representative sampling for text classification using support vector machines. In ECIR, 2003.
[51] Ofer Yehuda, Avihu Dekel, Guy Hacohen, and Daphna Weinshall. Active learning through a covering lens. In NeurIPS, 2022.
[52] Fedor Zhdanov. Diverse mini-batch active learning. arXiv preprint arXiv:1901.05954, 2019.
[53] Xiaojin Zhu, John Lafferty, and Zoubin Ghahramani. Combining active learning and semi-supervised learning using gaussian fields and harmonic functions. In ICMLW, volume 3, 2003.

1. A method for selecting a group of data points to be labelled in an active learning process, the method comprising:
determining a temperature parameter that selects between a representation-based point selection method and an uncertainty-based point selection method based on the current budget;
determining a kernel radius parameter that is inversely proportional to the size of the current budget;
estimating an uncertainty coverage based on the temperature parameter, the kernel radius parameter and the current budget, wherein the uncertainty coverage is a measure of how much uncertainty is covered by the group of data points; and
greedily selecting a next point based on the estimated uncertainty coverage.

2. The method of claim 1, wherein the representation-based data point selection method is a MaxHerding method.

3. The method of claim 1, wherein the uncertainty-based data point selection method of a Margin method.

4. The method of claim 1, wherein the step of greedily selecting a next point based on the estimated uncertainty coverage is repeated with an updated kernel value to the closest labeled data point until the budget is spent.

5. The method of claim 1, wherein the method is repeated for a number of iterations, and wherein the labeled and unlabeled data sets are updated before each iteration.

6. A non-transitory computer-readable storage medium storing a plurality of instructions executable by one or more processors, the plurality of instructions when executed by the one or more processors cause the one or more processors to execute the method claim 1.

7. A system comprising:
one or more computer processors; and
one of more computer readable storage media for storing computer-implemented instructions, wherein the one or more computer processors are configured to execute the computer-implemented instructions to cause the computer system to perform a method comprising:
determining a temperature parameter that selects between a representation-based point selection method and an uncertainty-based point selection method based on the current budget;
determining a kernel radius parameter that is inversely proportional to the size of the current budget;
estimating an uncertainty coverage based on the temperature parameter, the kernel radius parameter and the current budget, wherein the uncertainty coverage is a measure of how much uncertainty is covered by the group of data points; and
greedily selecting a next point based on the estimated uncertainty coverage.

8. The system of claim 7, wherein the representation-based data point selection method is a MaxHerding method.

9. The system of claim 7, wherein the uncertainty-based data point selection method of a Margin method.

10. The system of claim 7, wherein the step of greedily selecting a next point based on the estimated uncertainty coverage is repeated with an updated kernel value to the closest labeled data point until the budget is spent.

11. The system of claim 7, wherein the method is repeated for a number of iterations, and wherein the labeled and unlabeled data sets are updated before each iteration.
